(19) United States
(12) Patent Application Publication
(10) Pub. No.: US 2024/0402885 A1
(43) Pub. Date: Dec. 5, 2024

(54) METHOD, APPARATUS, DEVICE, AND STORAGE MEDIUM FOR INFORMATION PROCESSING

(71) Applicants: Beijing Zitiao Network Technology Co., Ltd., Beijing (CN); Lemon Inc., Grand Cayman (KY)

(72) Inventors: Xin Xie, Singapore (SG); Junyuan Qi, Beijing (CN); Bowen Shen, Beijing (CN); Yibing Zhu, Los Angeles, CA (US)

(21) Appl. No.: 18/731,107

(22) Filed: May 31, 2024

(30) Foreign Application Priority Data
Jun. 1, 2023 (CN) 202310644911.7

(51) Int. Cl. G06F 3/0483; G06F 3/0484; G06F 9/451

(52) U.S. Cl. CPC G06F 3/0483; G06F 3/0484; G06F 9/453; G06F 2203/04803

(57) ABSTRACT

According to the embodiments of the present disclosure, a method, apparatus, device, and storage medium for information processing are provided. The method includes in the presence of a first page collection, receiving a first instruction from a user through an interaction window between the user and a digital assistant, the first page collection comprising at least one page; and performing a target operation corresponding to the first instruction based on the first page collection. Therefore, the digital assistant can be applied in scenarios where there is a page collection, in order to provide users with convenient and efficient services.

### CROSS-REFERENCE

This application claims priority to Chinese Application No. 202310644911.7, entitled “method, apparatus, device, and storage medium for state prediction of a physical system” and filed on Jun. 1, 2023, which is hereby incorporated by reference in its entirety.

### FIELD

The example embodiments of the present disclosure generally relate to the field of computer science, particularly to method, apparatus, device, and computer-readable storage media for information processing.

### BACKGROUND

With the development of information technology, various terminal devices can provide people with various services in work and life. For example, applications that provide services can be deployed in terminal devices. Terminal devices or their applications can provide users with assistant functions to assist them in using terminal devices or applications to complete target tasks. How to make such assistant functions better serve users is currently a technical issue being explored.

### SUMMARY

In the first aspect of the present disclosure, a method of information processing is provided. The method comprises: in the presence of a first page collection, receiving a first instruction from a user through an interaction window between the user and a digital assistant, the first page collection comprising at least one page; and performing a target operation corresponding to the first instruction based on the first page collection.

In the second aspect of the present disclosure, an apparatus for information processing is provided. The apparatus comprises: an instruction receiving module configured to in the presence of a first page collection, receive a first instruction from a user through an interaction window between the user and a digital assistant, the first page collection comprising at least one page; and an operation execution module configured to perform a target operation corresponding to the first instruction based on the first page collection.

In the third aspect of the present disclosure, an electronic device is provided. The device includes at least one processing unit; and at least one memory coupled to the at least one processing unit and storing instructions for execution by the at least one processing unit, the instructions, when executed by the at least one processing unit, causing the electronic device to perform the method of the first aspect.

In the fourth aspect of the present disclosure, a computer-readable storage medium is provided. The computer-readable storage medium stores computer programs, which can be executed by a processor to implement the method of the first aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF THE DRAWINGS

The above and other features, advantages and aspects of various embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which the embodiments of the present disclosure can be implemented;

FIG. 2 shows a schematic diagram of different presentation manners for a plurality of pages in a paginated workflow according to some embodiments;

FIG. 3A and FIG. 3B illustrate schematic diagrams of example interfaces for invoking a digital assistant in a paginated workflow and displaying a conversational mode interaction window according to some embodiments;

FIG. 3C, FIG. 3D, and FIG. 3E illustrate schematic diagrams of example interfaces for invoking a digital assistant in a paginated workflow and interacting with the digital assistant through a conversation window according to some embodiments;

FIG. 3F shows a schematic diagram of another example interface of interacting with a digital assistant through a conversation window in a paginated workflow according to some embodiments;

FIG. 3G and FIG. 3H illustrate schematic diagrams of examples of non-conversational mode windows according to some embodiments;

FIG. 4A, FIG. 4B, and FIG. 4C illustrate schematic diagrams of example interfaces of adjusting the position of a conversation window according to some embodiments;

FIG. 5A, FIG. 5B, and FIG. 5C illustrate a schematic diagram of the page stack corresponding to the interfaces shown in FIG. 4A to FIG. 4C;

FIG. 6A and FIG. 6B illustrate a schematic diagram of a prompt message according to some embodiments;

FIG. 7A, FIG. 7B, and FIG. 7C illustrate schematic diagrams of interactive messages displayed in the form of aggregated messages according to some embodiments;

FIG. 8 shows a flowchart of a process of information processing according to some embodiments;

FIG. 9 shows a block diagram of an apparatus for information processing according to some embodiments;

FIG. 10 shows a block diagram of a device capable of implementing a plurality of embodiments of the present disclosure.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “comprising”, and similar terms would be appreciated as open inclusion, that is, “comprising but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

In the present disclosure, unless explicitly stated, performing a step in response to A does not mean performing the step immediately after A, but may include one or more intermediate steps.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, prompt information is sent to the user to explicitly prompt the user that an operation requested by the user will require obtaining and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

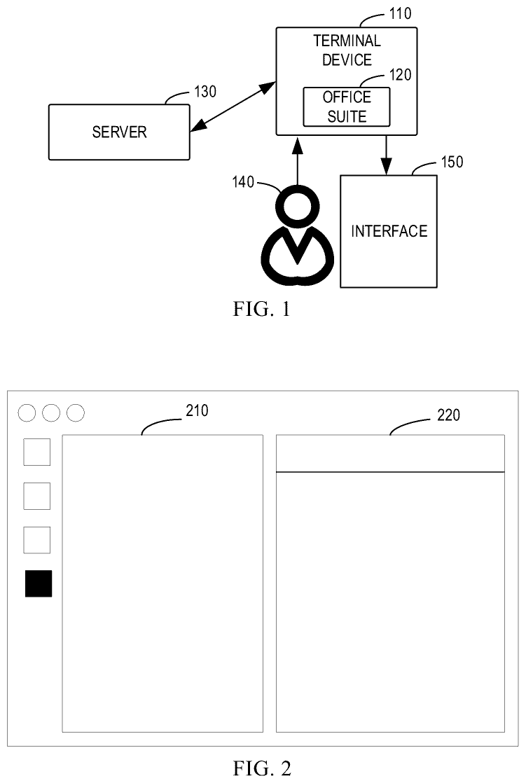

FIG. 1 illustrates a schematic diagram of an example environment 100 in which the embodiments of the present disclosure may be implemented. In the example environment 100, an office suite 120 is installed in a terminal device 110. A user 140 may interact with the office suite 120 through the terminal device 110 and/or attached devices of the terminal device 110. The office suite 120 may provide integration of a plurality of components to the user 140. These components may serve as component modules in the office suite 120. The components integrated in the office suite 120 are sometimes referred to as “office applications”, “office components”, “collaborative office platforms”, etc. As an example, the components integrated in the office suite 120 may include but are not limited to one or more of: a chat component (also referred to as instant messaging (IM) components), a document component, an audio and video conferencing component, an email component, a calendar component, a schedule component, a task component, an Objectives and Key Results (OKR) component.

In some embodiments, the office suite 120 may be downloaded and installed as an application on the terminal device 110. In some embodiments, the office suite 120 may also be accessed through other means, such as web access.

In the environment 100 of FIG. 1, if the office suite 120 is activated, the terminal device 110 may present an interface 150 of the office suite 120 to user 140. The interface 150 is sometimes referred to as a client interface. The interface 150 may include various interfaces that the office suite 120 can provide, such as a conversation interface for presenting chat content, a video conference interface, a file sharing interface, and so on.

In some embodiments, the terminal device 110 communicates with a server 130 to supply services to the office suite 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination of the above devices, including accessories and peripherals for these devices, or any combination thereof. In some embodiments, the terminal device 110 can also support any type of interfaces (such as wearable circuits) for users. The server 130 may be of various types of computing systems/servers that can provide computing power, including but not limited to mainframe, edge computing nodes, computing devices in cloud environment, and so on.

It should be understood that describing the structure and function of each element in the environment 100 is for illustrative purposes only, and does not imply any limitations on the scope of the present disclosure. For example, the embodiments of the present disclosure may be applied to any suitable one or more applications, not limited to office suites.

As briefly mentioned earlier, digital assistants may be provided to users to assist them in using terminal devices or applications to complete target tasks. On the other hand, with the continuous development of artificial intelligence (AI), it is also expected to use AI to bring new experiences to users, such as in office applications. Some related solutions may use digital assistants to help users create content, generate presentations, organize emails, and extract to-do items. In practical applications, there may be a plurality of scenarios. Therefore, it is expected that digital assistants can provide users with services corresponding to different scenarios. As a practical scenario, a page collection (such as the pagination workflow described below) includes at least one page. How to use a digital assistant in the scenario of page collections is the solution discussed in the present disclosure.

To this end, embodiments of the present disclosure propose a solution for information processing. According to various embodiments of the present disclosure, in the presence of a page collection (which includes at least one page), an instruction from a user is received through an interaction window between the user and the digital assistant. Furthermore, a target operation corresponding to the instruction is performed based on this page collection. For example, the target operation may be to close one or more pages in the page collection, extract information from the page collection and display it to the user, edit a page in the page collection, and so on. As such, applying the digital assistant in the scenario where there is a collection of pages is beneficial for improving user processing efficiency for page collections. In this way, users can be provided with convenient and efficient services.

In embodiments of the present disclosure, a page collection has at least one page. In some embodiments, a page collection may be a collection of pages that have been manipulated during a pre-determined time period. The “operations” described here may include various operations on a page, such as opening, topping, bookmarking, tagging, etc. It may also include operations performed on content in the page, such as deleting or inserting content.

Alternatively, or additionally, in some embodiments, the page collection may be a collection of pages that have been manipulated during a pre-determined time period and are in an open state upon receiving the user instruction. In other words, the page collection may be a collection of pages that are in an open state when the user sends the instruction to the digital assistant.

In some embodiments, a page collection may be a collection of pages that are in the open state and meet a pre-determined association condition. For example, these pages may be a plurality of pages opened by the user separately, and in the case of meeting the pre-determined association condition, these pages may form a page collection. For example, the pre-determined association condition may be that these pages were opened within the same time period. For another example, the pre-determined association condition may be that the plurality of pages are of the same type, such as a plurality of chat pages. The embodiments of the present disclosure do not limit the possible implementation of the pre-determined association condition.

In some embodiments, a page collection may be a collection of pages identified as associated with each other based on a user input. For example, the user actively associates a plurality of open pages into a page collection.

In some embodiments, a page collection may be a collection of pages opened in association. Opened in association refers to that a page is opened based on another page, for example, based on a control or displayed content in the other page. In embodiments of the present disclosure, such a page collection is also referred to as a pagination workflow. In other words, the pages opened in association form a pagination workflow.

For some pagination workflows, the plurality of pages thereof may be sequentially opened from a root page in association, and these pages form a linear relationship based on the relationship as opened in association. As an example, page B is opened based on a control or displayed content in page A, and page C is opened based on a control or displayed content in page B. In this case, page A, page B, and page C may form a pagination workflow.

For some other pagination workflows, the plurality of pages thereof may be sequentially opened from a root page in association, and these pages form a tree like relationship based on the relationship as opened in association. For example, page E is opened based on a control or displayed content in page D, page F is opened based on a control or displayed content in page E, and page G is opened based on another control or displayed content in page E. In this case, page D, page E, page F, and page G form a pagination workflow. In some embodiments, such a root page may be used to distinguish different pagination workflows, for example, different pagination workflows have different root pages. Therefore, by determining the root page corresponding to a certain page, the pagination workflow to which the page belongs may be determined.

A plurality of pages in the same pagination workflow may belong to the same component or different components of the same application. For example, the components in the office suite 120 include but are not limited to one or more of the following: an instant messaging component, a document component, an audio and video conferencing component, an email component, a calendar component, a schedule component, a task component, an OKR component, and so on. A plurality of pages in a paginated workflow may belong to a component in the office suite 120 or belong to different components in the office suite 120, and the present disclosure does not limit in this regard. In some embodiments, pages within the same pagination workflow may include a page external to the application, such as a webpage link that is opened in a session of an office suite application and does not belong to the office suite.

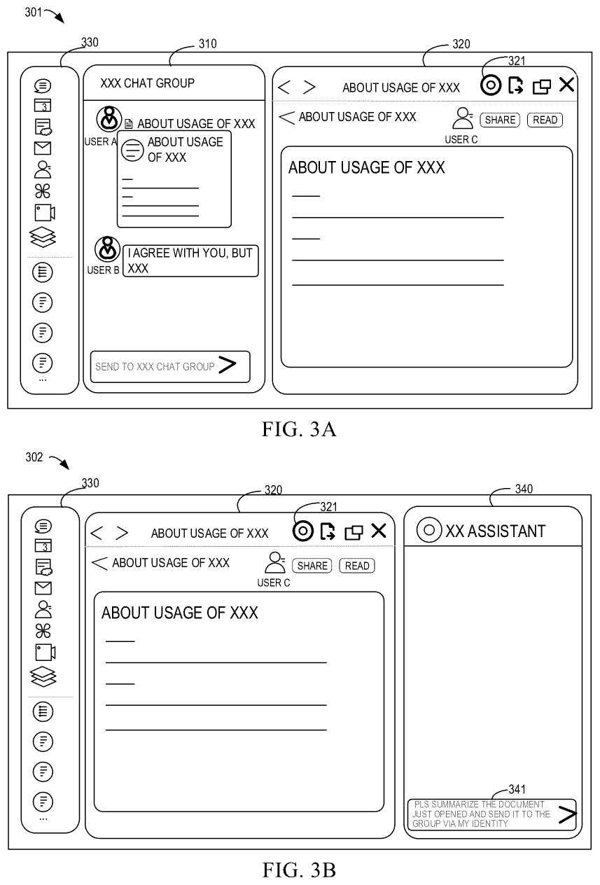

The plurality of pages in the same pagination workflow may be presented through screen splitting, different independent windows, hovering, or a combination thereof, and the present disclosure of embodiments is not limited in this regard. Reference is made to FIG. 2 where the first page 210 and second page 220 displayed by screen splitting belong to one pagination workflow.

In order to provide a clearer description of the embodiments of the present disclosure, some example embodiments of the present disclosure are described with respect to the accompanying drawings. In the following, the pagination workflow in the office suite is mainly described as an example scenario, but this is only for illustrative purposes and is not intended to limit the scope of the present disclosure. A pagination workflow is an example of a page collection that may be utilized with a digital assistant for other page collections. In addition, the digital assistant may be implemented in any other scenario where there is a page collection, without limitation to office suites.

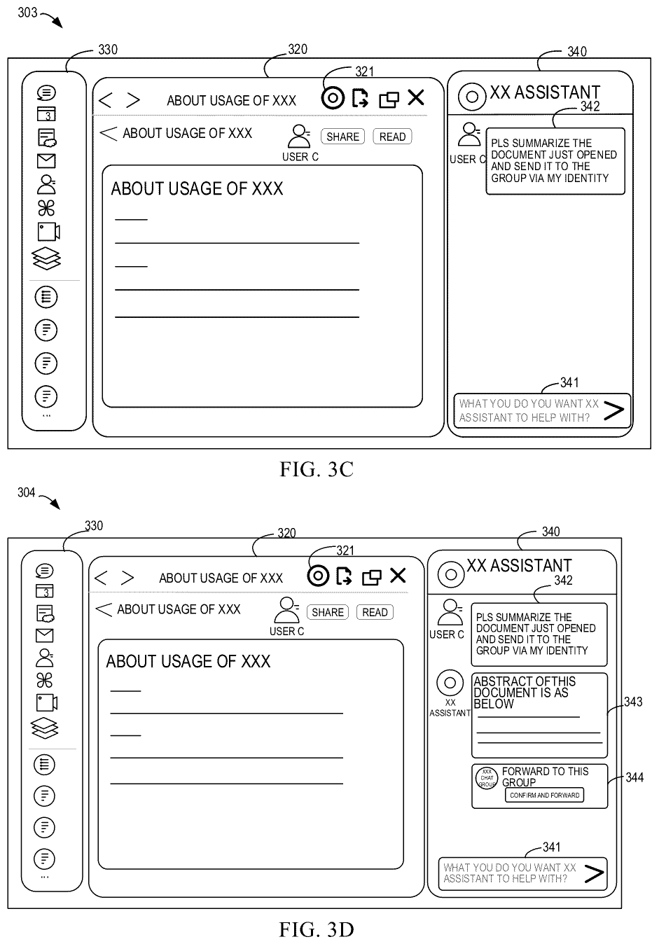

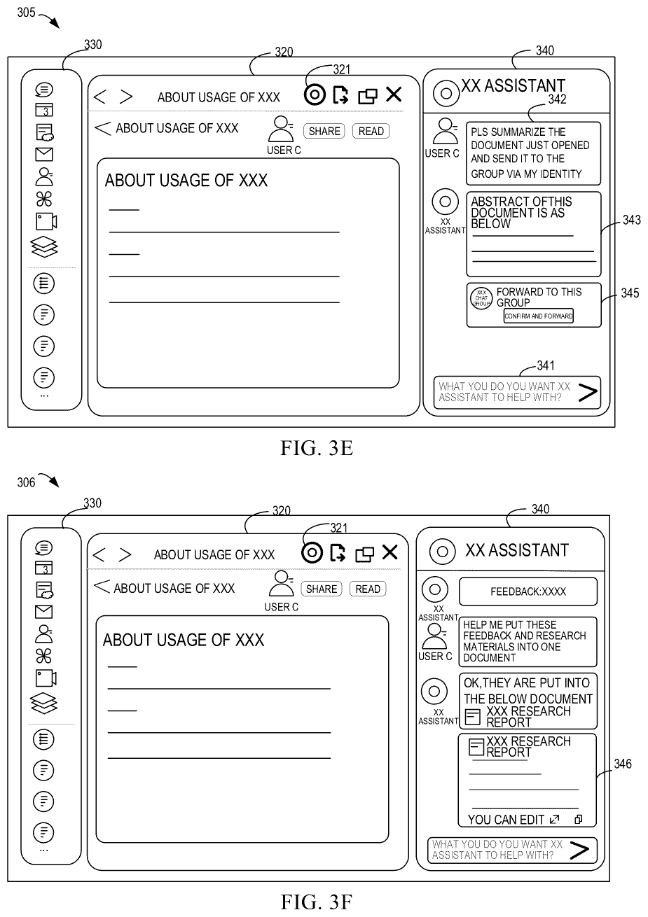

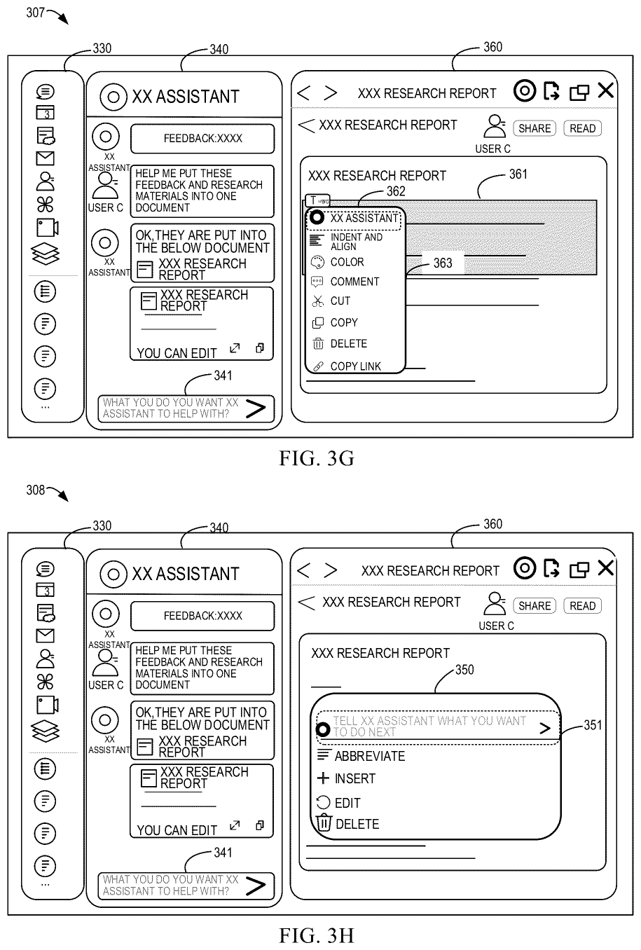

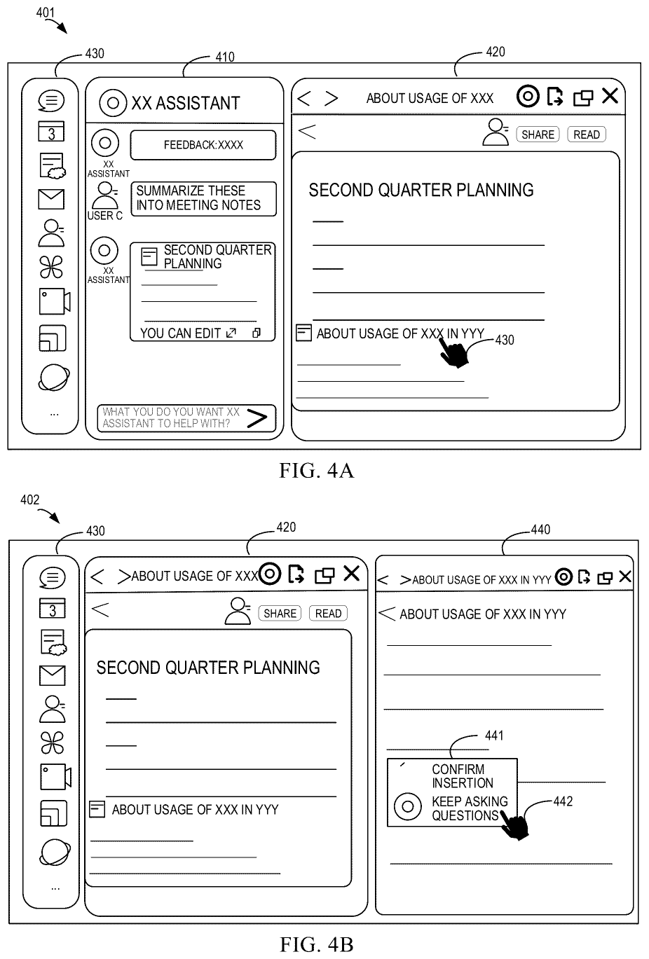

Reference is made to FIG. 3A to describe an example of a pagination workflow in an office suite. The terminal device presents an interface 301 of the office suite. The interface 301 includes a navigation bar 330, with entry controls for a plurality of components and access entries for the plurality of pages displayed therein. By selecting these entry controls and access entries, corresponding components or pages may be activated for browsing or operation. In this example, the chat component is activated. Correspondingly, the chat page 310, also referred to as the chat window, is presented in the interface 301. Based on the chat records displayed in the chat page 310, the document “ABOUT USAGE OF XXX” is opened, thus presenting the page 320 for the document. In this example, the page 310 and page 320 are opened in association, therefore belonging to the same pagination workflow.

In embodiments of the present disclosure, a digital assistant is configured for the user 140. The digital assistant may be implemented in any suitable form. In some embodiments, the digital assistant for the user 140 may interact with the user 140 as a contact person of the user 140. Such a digital assistant may uniquely correspond to the user 140. In other words, the digital assistant for the user 140 may be specific to or exclusive to the user 140. For example, in the process of providing assistance or services to the user 140, the digital assistant may utilize its historical interaction information with the user 140, the data authorized by the user 140 to access, its current conversation content with the user, and so on. If the user 140 is an individual or a person, such a digital assistant may be considered a personal digital assistant. It may be understood that the digital assistant is based on the authorization of the user 140 to access the data that has been granted permission in the embodiments of the present disclosure.

It should be understood that the term “unique correspond” or similar expressions in the present disclosure are not intended to limit the digital assistant to be updated accordingly based on the interaction process between the user 140 and the digital assistant.

In some embodiments, the digital assistant may be implemented in a single component or application, such as an IM component. In some embodiments, the digital assistant may be implemented in a plurality of components. For example, these components may be different components of an office suite or collaborative office platform. In some embodiments, the digital assistant may be directly implemented in the terminal device 110 without relying on any application. In such embodiments, the digital assistant provides assistance to the user 140 in the form of a contact person.

In the presence of a pagination workflow, the user 140 may invoke the digital assistant in various appropriate ways. Through the interaction window with the digital assistant, it is possible to enable the digital assistant to assist in operations related to a certain pagination workflow (also referred to as the first pagination workflow or the target pagination workflow).

In some embodiments, the involving of the digital assistant may be independent of a specific pagination workflow. As an example, the digital assistant may be invoked by means of search so as to interact with it. For example, the user 140 may enter keywords related to the digital assistant (such as the name of the digital assistant, remark name) in the search block. As a response, an option related to the digital assistant may be presented as a search result. The user 140 invokes the digital assistant and initiates a conversation window with the digital assistant by clicking on this option. As another example, the digital assistant may be invoked through a contact list or address book. For example, the contact option corresponding to the digital assistant may be presented in the contact interface. In this way, a stable entry for the digital assistant may be provided, so that the user 140 can easily invoke the digital assistant as needed.

In some cases, if there is a pagination workflow, the pagination workflow is determined to be the first pagination workflow. In other cases, there may be a plurality of pagination workflows. In these cases, the first pagination workflow is determined from the plurality of pagination workflows. Based on this first pagination workflow, the user interacts with the digital assistant.

Therefore, in some embodiments, in the presence of a plurality of pagination workflows, a pagination workflow selection control may be presented. The pagination workflow selection control may include options for the plurality of pagination workflows currently existing for the user to select, or allow the user to input information about the pagination workflow expect to process. Correspondingly, the terminal device may receive an operation on the pagination workflow selection control by the user, and select the first pagination workflow from these pagination workflows based on the user's operation.

In some embodiments, the process of determining the first pagination workflow mentioned above may occur after the digital assistant is invoked. For example, based on the interaction between the digital assistant and the user, the user may be prompted to determine the first pagination workflow from the plurality of pagination workflows. In some other embodiments, the process of determining the first pagination workflow mentioned above may occur before the digital assistant is invoked. For example, after the user initiates an operation or instruction to invoke the digital assistant but before the digital assistant is invoked, the user may be prompted to determine the first pagination workflow from the plurality of pagination workflows, and then invoke the digital assistant after the user confirms the first pagination workflow. In some further embodiments, the process of determining the first pagination workflow mentioned above may occur after the digital assistant is invoked and the user 140 sends an instruction to the digital assistant. For example, if the digital assistant is unsure on which pagination workflow to perform the operation on, it prompts the user to determine the first pagination workflow from the plurality of pagination workflows.

In some embodiments, the involving of the digital assistant may be associated with a certain pagination workflow. For example, the digital assistant may be invoked in response to involving of the digital assistant in the pagination workflow. In such embodiments, the relevant pagination workflow is the first pagination workflow.

In some embodiments, the terminal device 110 may present, in a pagination workflow, an option or control related to the digital assistant. If the user 140 selects the option (for example, clicking on the option) or the control, the digital assistant is invoked. As an example, a digital assistant entry control may be presented at a pre-determined position on one or more pages of the first pagination workflow. By triggering the digital assistant entry control displayed at the pre-determined position of a page (also referred to as the first page or invoking page) in the first pagination workflow, the digital assistant may be invoked, thus presenting the interaction window between the user and the digital assistant. The invoking page may be any page included in the first pagination workflow. For example, the invoking page may be the latest opened page in the first pagination workflow, or it may also be the last activated page by the user. The pre-determined location may be anywhere on the page. The embodiments of the present disclosure do not limit the layout position of the digital assistant entry control.

As an example, still referring to FIG. 3A, the navigation bar located at the top of the triggered, the digital assistant is invoked and the interface 301 is redirected to an interface 302 as shown in FIG. 3B. In the interface 302, a conversation window 340 is displayed for interaction between the user and the digital assistant, and the conversation window 340 is an example implementation of the interaction window between the user and the digital assistant. In addition, the page 310 is “hidden”, and the display position of the page 320 changes and is split from the conversation window 340. In the conversation window 340, the user may input messages through an input block 341 or other appropriate means (such as voice). The user messages may include or represent instructions from the user. The message in the conversation window may also be referred to as a conversation message. The content associated with a conversation message may be any appropriate format, such as formats of text, image, audio, or video. In the example in FIG. 3B, the conversation message entered by the user is “please summarize the document just opened and send it to the group via my identity”.

In the above examples and the following examples, the digital assistant is shown with the name “xx assistant”, but it should be understood that this is only illustrative and not intended to limit the scope of the present disclosure. In the embodiments of the present disclosure, the digital assistant may have any suitable name.

In the above embodiments, the digital assistant entry control is displayed at the pre-determined position in the page. Alternatively, or additionally, in some embodiments, the entry control for the digital assistant may be invoked in response to a predetermined operation being performed on the page. Then, if the invoked entry control is triggered, the digital assistant may be invoked. For example, the user may perform a pre-determined operation on the content displayed in a page in the first pagination workflow (such as selecting content and right-click) to invoke the entry control for the digital assistant, and then click on the entry control to invoke the digital assistant. The pre-determined operation may include clicking, pressing for a pre-determined duration, a voice command, and other operations, as well as a shortcut operation customized by the user. The present disclosure does not limit the specific implementation of the predetermined operation. The following text will refer to FIGS. 3G and 3H to describe such an example.

The invoking of the digital assistant is described above with reference to the example of the pagination workflow. It should be understood that this is only illustrative. The embodiments described with reference to the pagination workflow may be applied to other types of page collections. Next, the example embodiments are described by using the pagination workflow as an example.

In some embodiments, the digital assistant may obtain the information of the first pagination workflow, which includes various forms of information related to the first pagination workflow. For example, this information may include identification information (ID or link address, etc.) of each page in the first pagination workflow, through which the content of the page may be accessed. For example, this information may include information related to the content displayed in a plurality of pages in the first pagination workflow, such as chat content, images, and information on the files involved in the chat page. For example, this information may include layout information and order information of different pages in the first pagination workflow, such as window sizes of different pages, location information in the user interface, and an order of being opened. In this way, the interaction between the user and the digital assistant in the interaction window (such as the conversation message in the conversation window) may be based on the corresponding content of the plurality of pages in the first pagination workflow.

In some embodiments, the information of the first pagination workflow may be obtained after the digital assistant is invoked. Furthermore, upon receiving the instruction from the user 140, the digital assistant may perform the target operation corresponding to the user's instruction based on the obtained information of the first pagination workflow. In this way, the digital assistant obtains the information of the first paging workflow after being invoked, so that the digital assistant may quickly respond to the first instruction and perform the correct operation after receiving it. Since the processing of user instructions is based on the information of the pagination workflow, the user may provide instructions in a simple and concise manner (for example, referring to the example described in FIG. 3 below), thereby improving the efficiency of processing on the pagination workflow by the user.

In some embodiments, after the digital assistant is invoked, the user 140 may issue an instruction to the digital assistant. After receiving the instruction from the user 140, the digital assistant may obtain the information related to the instruction in the first pagination workflow. Furthermore, the digital assistant may perform the corresponding target operation based on the obtained information. In this way, it is possible to reduce the amount of information required for the digital assistant to obtain, by only obtaining information related to the current instruction.

In the embodiments of the present disclosure, the target operation may include any suitable operation. For example, the target operation may include closing one or more pages in the pagination workflow, opening one or more documents, summarizing or extracting partial information from the pagination workflow and displaying it to the user, collaborating with the user to edit a page in the pagination workflow, and so on.

In some embodiments, the target operation may include a plurality of operations, in other words, the instruction from the user may indicate a plurality of operations. As an example, the target operation may include a first operation and a second operation. So, performing the target operation may involve further interaction between the user and the digital assistant. For example, after obtaining the result of the first operation, an interaction message from the digital assistant may be presented through the interaction window, which indicates the user to confirm the result of the first operation. If the user confirms the result of the first operation, the second operation may be performed based on the result of the first operation.

As an example, referring to FIG. 3B, the user enters the message “please summarize the document just opened and send it to the group via my identity” in the input block 341 and clicks sending. Correspondingly, the interface 303 shown in FIG. 3C is presented. In the interface 303, a conversation message entered by the user is displayed in the conversation block 342 in the conversation window 340. In response to the conversation message entered by the user, the digital assistant performs the first operation, which is to obtain the content of the document displayed in the page 320 and summarizes the document. Then, the summary obtained by summarizing the document is presented as a reply message to the user and the user is instructed to confirm. Referring to the interface 304 shown in FIG. 3D, interactive messages from the digital assistant are displayed in the conversation block 343 and prompt block 344 in the conversation window 340. The interactive messages include a document summary displayed in the conversation block 343 and a prompt message displayed in the prompt block 344 to confirm whether to forward to “XXX group” for the user. In response to a triggering operation by the user on the “confirm and forward” in the prompt block 344, the digital assistant performs the second operation, which is to forward the document to the user's designated chat group and prompt the user that it has been successfully forwarded. Referring to an interface 305 shown in FIG. 3E, the user is prompted in the conversation block 345 in the conversation window 340 that the forwarding is successful. From this example, it may be seen that the user can simply provide instructions without giving the full name of the page they want to process, in order to achieve the desired operation. This improves the efficiency of users in handling page collections.

In some embodiments, the target operation may include updating of the target page. Accordingly, in response to the completion of the target operation, an option regarding whether to present the updated target page may be provided in the interaction window. Continuing with the previous example, the target operation includes forwarding the summary of the document to the “XXX group”. In this case, after the target operation is completed, the chat page (such as the conversation window) of the “XXX group” is updated. So, the option to display the chat page for “XXX Group” may be presented in the interaction window. In such embodiments, if the user expects to switch to the target page after the target operation is completed, the user may choose to present the target page for subsequent operations. If the user only expects to update the target page without the need to switch to the target page, the user may choose not to present the target page or not to make a selection. In this way, the user may make flexible choices based on their actual situation.

The user and the digital assistant may engage in a plurality of rounds of interaction. As an example, based on the feedback provided by the digital assistant in the previous round of interaction, the user may further issue an instruction to the digital assistant. Referring to an interface 306 shown in FIG. 3F, the user provides through the conversation window 340 an instruction “help me put these feedback and research materials into one document”. As a response, the digital assistant generates a research report and displays a preview and a link to the document in conversation block 346. In addition, the user may be prompted to perform editing and other operations on the research report. As another example, if the digital assistant is unsure of the meaning of the user's instruction, a plurality of rounds of interaction may be conducted. For example, the user's instruction is “send to this group”. The digital assistant may prompt the user to identify a plurality of groups from the pagination workflow and further determine which groups to send.

The interaction window between the user and the digital assistant may be any form or mode of window. In some embodiments, the interaction window between the user and the digital assistant may be a conversational mode window, such as the conversation window 340 in FIGS. 3B to 3F. Alternatively or additionally, in some embodiments, the interaction window between the user and the digital assistant may be a non-conversational mode window. An example of the non-conversational mode is the floating window mode, which will be described in the following with reference to FIGS. 3G and 3H. The way to trigger the non-conversational mode window may be that the user performs a pre-determined operation on any page of the pagination workflow, or any other operations. There is no limitation in this regard in the embodiments of the present disclosure.

Continue with the example in FIG. 3F. The document “XXX Research Report” has been updated and the user has chosen to present it. Correspondingly, the interface 306 is switched to an interface 307 shown in FIG. 3G, where the page 360 for the document “XXX Research Report” is displayed. In the page 360, the user selects the content 361 and triggers a panel 363. The entry control 362 for the digital assistant is displayed in the panel 363. In response to the user triggering the entry control 362, the interface 307 is switched to the interface 308 shown in FIG. 3H. As shown in FIG. 3H, a functional panel 350 is displayed in the page 320, which includes a non-conversational mode window 351 for interacting with the digital assistant, also referred to as a floating window. The user may input an instruction in the non-conversational mode window 351 to instruct the digital assistant to perform an operation corresponding to the instruction.

In some embodiments, the interaction information about the first pagination workflow in the non-conversational mode window may be synchronized to the conversational mode window. For example, the instructions entered by the user in non-conversational mode window 351 and the responses by the digital assistant may be synchronized to the conversational mode window 340.

The interaction window between the user and the digital assistant are described above with reference to the example of the pagination workflow. It should be understood that this is only illustrative. The embodiments described with reference to the pagination workflow may be applied to other types of page collections.

In some embodiments, the interaction window between the user and the digital assistant (e.g., the conversation window 340) may be considered as one of the pages in the pagination workflow. Correspondingly, the interaction window may be sorted along with other pages in the pagination workflow based on the time it was activated, which is a type of time sorting.

The number of pages that a user's client interface can display simultaneously is limited. If the number of pages included in the pagination workflow exceeds the maximum number of pages that can be displayed simultaneously on the client interface, some pages in the pagination workflow cannot be displayed. For example, pages ranked higher (i.e. pages with earlier activation times) cannot be displayed. In some cases, the interaction window between the user and the digital assistant may also not be displayed. In this case, if the digital assistant is invoked again, it is necessary to adjust the display rule or order of the pages so that the interactive window is displayed in the client interface.

In some embodiments, the user's client interface may be configured to display N pages simultaneously, where N is a positive integer. So, in the case where the number of pages included in the first pagination workflow is greater than N, the N pages ranked lower in the first pagination workflow are presented in the client interface, and these displayed pages do not include the interaction window, that is, the interaction window is not displayed in the client interface. The plurality of pages in the first pagination workflow may be sorted based on their last activation times. The later the last activation time, the lower the ranking of the page. The “activation” described here may refer to any form of access to the page, such as browsing, editing, etc. The ranking of pages may also be determined according to other algorithms or rules, and the present disclosure is not limited. In this case, if the digital assistant is invoked again, the sorting of the interaction window in the first pagination workflow may be adjusted so that the interaction window is presented in the client interface.

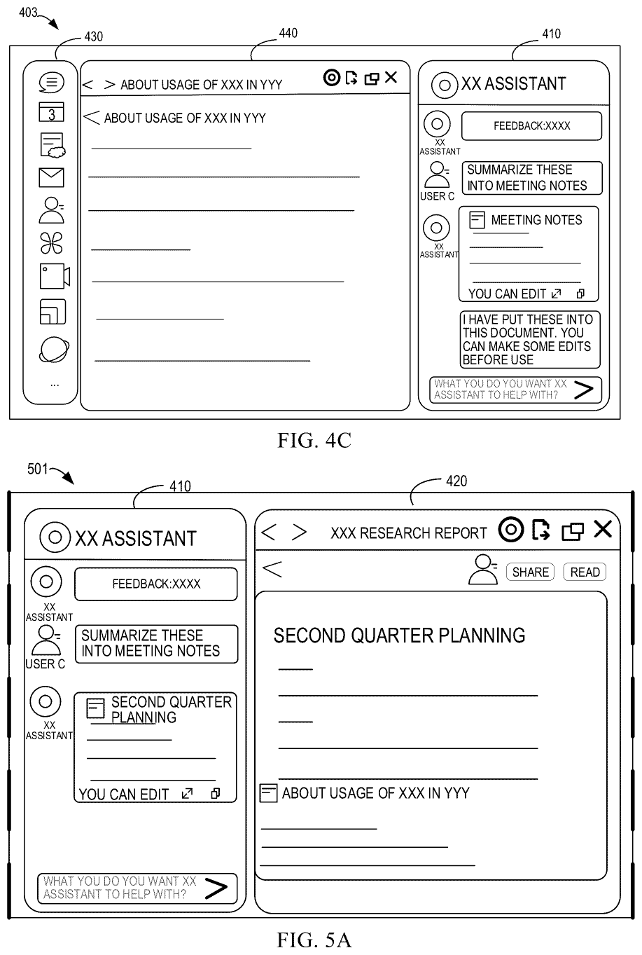

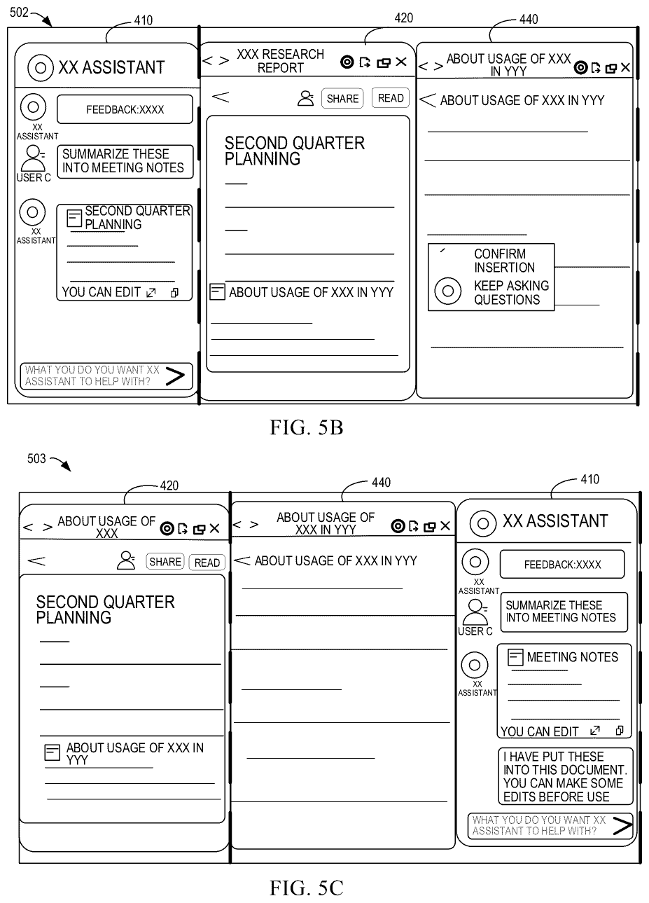

As an example, referring to FIG. 4A, the interface 401 is displayed with a navigation bar 430 and a plurality of pages in the first pagination workflow, namely an interaction window 410 and a page 420. The corresponding page stack is shown in FIG. 5A, which includes the interactive window 410 and the page 420, and these two pages are arranged in a certain order in the page stack. Continuing with reference to FIG. 4A, as shown by a flag 430, the user has opened the document “about usage of XXX in YYY” in the page 420. Correspondingly, the interface 402 shown in FIG. 4B is presented. In the interface 402, the interaction window 410 is not displayed, but a page 440 of the document “about usage of XXX in YYY” is displayed. The page stack corresponding to the interface 402 is shown in FIG. 5B, where the black dashed lines represent the areas corresponding to the client interface, which represents the pages visible to the user (as shown in FIG. 5C). The page stack 502 includes the interaction window 410, the page 420, and the page 440, and these three pages are arranged in the order of the most recent activation times. The page 420 and page 440 are visible to the user, and the interaction window 410 is not displayed. It may be seen that although the interaction window 410 is not displayed in the client interface, it still remains in the page stack. Continuing with reference to FIG. 4B, a floating window 441 is displayed in the page 440, which includes the option “keep asking questions” whether to continue interacting with the digital assistant. If the user selects the option “keep asking questions”, the digital assistant may be invoked again. Correspondingly, the interface 403 shown in FIG. 4C is presented. In the interface 403, the interaction window 410 is displayed to the user again. The page stack corresponding to the interface 403 is shown in FIG. 5C. Compared with the page stack 502, in this page stack 503, the order of the interaction window 410, page 420, and page 410 is adjusted, so that the interaction window 410 can be displayed.

In some embodiments, when the digital assistant is working on the first pagination workflow, the user may be prompted that the digital assistant is working on the first pagination workflow. The user may be presented with visual information, such as text, graphics, etc. The user may be prompted through other forms, such as voice broadcasting. Taking visual information as an example, the prompt information may be presented in the interaction window, which is used to prompt the user that the digital assistant is currently working based on the first pagination workflow. In some embodiments, the prompt information may include one or more page identifications, which are used to indicate the page on which the digital assistant is currently working. The page identification may vary for different types of pages. Alternatively, or additionally, in some embodiments, the prompt information may include the identification of the first page collection, which is the identification of the pagination workflow in the case of the first page collection being a pagination workflow. For example, the identification of the first page collection (such as a pagination workflow) may be determined by the system or the user. The identification may be different from the identification of any page included in the first page collection, or it may be the same as the identification of one of the pages, without limitation in this regard.

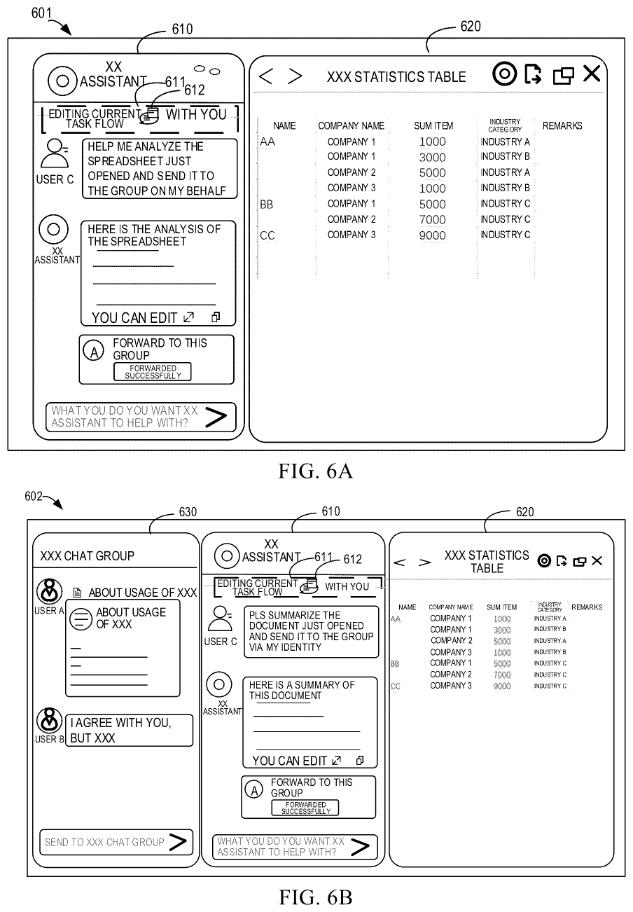

For example, referring to the interface 601 in FIG. 6A, the digital assistant analyzes the table shown in the page 620 and forwards the analysis result to the group chat. Correspondingly, the prompt information 611 “editing the current task flow with you” may be displayed in the interaction window 610, and the prompt information 611 also includes the identification 612 of the page in the pagination workflow. FIG. 6B shows the page stack 602 corresponding to the interface 601. The page stack 602 includes the group chat page 630 and the table page 620 involved in the current work of the digital assistant.

In some embodiments, for different pagination workflows, the digital assistant may present interactive information based on contextual information, thus matching it with the current pagination workflow. For example, after switching from the first pagination workflow to the second pagination workflow, the interaction information obtained and presented by the digital assistant is related to the second pagination workflow.

The user and the digital assistant may interact for different pagination workflows, and that a plurality of rounds of interaction may be involved for each pagination workflow, thus including a plurality of interaction messages.

To this end, in some embodiments, a plurality of interaction messages between the user and the digital assistant regarding the first pagination workflow may be presented in an aggregated form in the conversational mode window. The aggregated form may be in the form of topic messages or other possible string of messages, without any limitation in this regard. By aggregating messages, it is possible to avoid confusion in the interaction information between different pagination workflows.

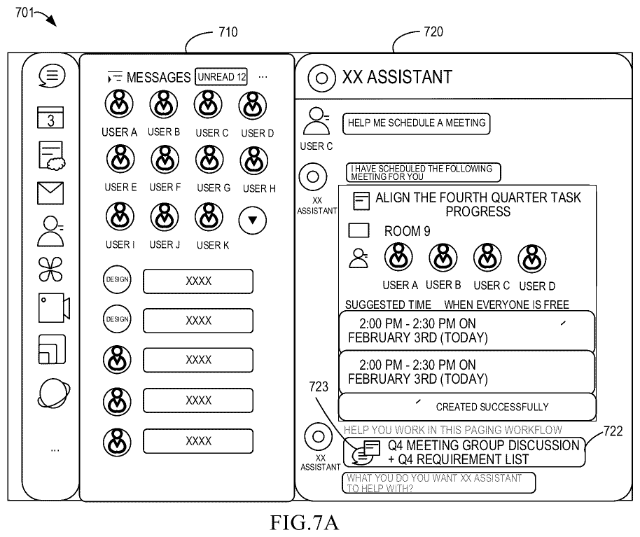

In some embodiments, the aggregated form may take the form of sub conversations. In other words, a plurality of interaction messages between the user and the digital assistant regarding the first pagination workflow may be presented as a sub conversation in the conversational mode window. Reference is made to an interface 701 in FIG. 7A. A plurality of pieces of interaction information between the user and the digital assistant regarding the first pagination workflow is presented as a sub conversation 722 in the interaction window 720. The text in the sub conversation 722 may indicate the name of the page in the pagination workflow. Furthermore, the user may click on the sub conversation 722 to expand the interaction messages thereof, and may further input a new conversation message.

In some embodiments, the aggregated form may be in the form of topic messages. Now refer to the interface 702 in FIG. 7B. A plurality of pieces of interaction information between the user and the digital assistant regarding the first pagination workflow is presented in the form of topic message 741 in the interaction window 740. Furthermore, the user may click anywhere in the display area of the control 742 or the topic message 741 to expand interactive messages, and the user may also respond. Refer to the interface 703 in FIG. 7C. A floating window 750 is presented. The interaction messages between the user and the digital assistant are expanded in the floating window 750, and the user may provide a further conversation message through an input block 751. In this way, it is possible to avoid confusion of interaction information between different pagination workflows. In addition, if there are relatively large number of interaction messages, a plurality of interaction messages may be aggregated and displayed in the conversation mode window. In this way, the user may expand their interaction messages according to their own needs, or not expand their interaction messages.

In some embodiments, the identification of the page in the pagination workflow or the identification of the pagination workflow may be presented in a conversational mode window together with interactive messages in the aggregated form. For example, in the example of FIG. 7A, the identification 723 of the pages in the processed pagination workflow is presented in the interaction window 720, and the identification 723 includes the identification of the group chat “Q4 meeting group discussion” and the identification of the table “Q4 requirement list”. For example, in the example of FIG. 7B, the identification 743 of the page is presented in the interaction window 740, which includes the identification of the group chat and the identification of the document. It should be understood that the position of the identification 743 shown in FIG. 7B is only illustrative without any limitation. The page identification and prompt information may be presented in any appropriate location. For example, the page identification and/or prompt information may be presented within the presentation area of the topic message 741.

Example interfaces for setting up and interacting with the digital assistant through dialogue are described above with reference to the accompanying drawings. It should be understood that the various interfaces and interface elements, text, etc. described above are exemplary and not intended to limit the scope of the present disclosure. Furthermore, it should be understood that the various embodiments described above may be implemented individually or in combination.

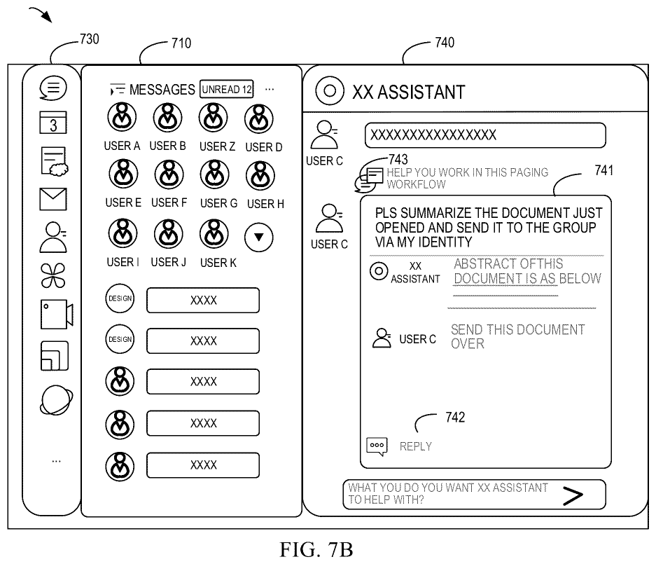

FIG. 8 shows a flowchart of a method 800 of processing information according to some embodiments. The method 800 may be implemented at the terminal device 110. The method 800 is described below with reference to FIG. 1.

In block 810, the terminal device 110 receives a first instruction from a user through an interaction window between the user and the digital assistant in the presence of a first page collection. The first page collection includes at least one page.

In some embodiments, the first page collection includes one or more of: a collection of pages that have been manipulated during a pre-determined time period; a collection of pages that have been manipulated during a pre-determined time period and are in an open state upon receiving the first instruction; a collection of pages identified as associated with each other based on a user input; a collection of pages that are in an open state and meet a pre-determined association condition; or a collection of pages opened in association.

For example, as discussed above, an office suite may include a plurality of components (also referred to as office components), examples of which may include but are not limited to: a chat component, a document component, an audio and video conference component, an email component, a calendar component, a schedule component, a task component, an OKR component, and/or appropriate office components that are currently existing or may be developed in the future. The first page collection includes a plurality of opened pages, which belong to the same or different components. A plurality of opened pages may be presented to the user in various ways. In some embodiments, the plurality of pages in the first page collection are opened in association.

As discussed above, there are various ways to invoke the digital assistant. In some embodiments, a digital assistant entry control is presented at a predetermined position on the first page in the first page collection. The digital assistant is invoked by triggering the digital assistant entry control, and the digital assistant entry control is invoked by performing the predetermined operation on the first page in the first page collection. Then, the digital assistant is invoked by triggering the entry control. In some embodiments, it is also possible to invoke the digital assistant through search, or through contact lists or contacts to invoke the digital assistant.

As discussed above, in some embodiments, the interaction window between the user and the digital assistant is a conversational mode window, also referred to as the conversation window. In some embodiments, the interaction window between the user and the digital assistant is a non-conversational mode window. The instructions entered by the user in the non-conversational mode window may be synchronized to the conversational mode window.

In some embodiments, in the presence of a plurality of page collections, in order for the digital assistant to determine contextual information, it is necessary to determine the first page collection and provide contextual information to the digital assistant based on the information of the first page collection. Therefore, in the presence of the plurality of page collections including the first page collection, the first page collection is determined from the plurality of page collections. That is, before receiving the first instruction from the user, the page collection selection control is presented; and user selection of the first page collection is received through the page collection selection control.

In block 820, the terminal device 110 performs a target operation corresponding to the first instruction based on the first page collection.

In some embodiments, in response to the invoking operation on the digital assistant in the first page collection, the information of the first page collection is obtained to enable the target operation corresponding to the first instruction to be perform based on the first page collection upon receiving the first instruction. In this way, the digital assistant, upon being invoked, obtains the information in the first paging stream. As such, the digital assistant may quickly respond to the first instruction upon receiving it.

In some embodiments, after receiving the first instruction, the digital assistant obtains the information of the first page collection based on the first instruction, and then performs an operation corresponding to the first instruction based on the obtained information. In this way, it is possible to reduce the amount of information required for the digital assistant to obtain, by only obtaining information related to the current instruction.

In some embodiments, prompt information is presented in the interaction window to prompt the user that the digital assistant is currently working based on the first page collection. In this way, visual communication is used to remind users that the digital assistant is working, thus improving the user experience.

In some embodiments, the prompt information includes an identifier of at least one page included in the first page collection or an identifier of the first page collection.

In some embodiments, the first page collection comprises a first pagination workflow composed of pages opened in association; and the interaction window is one of the pages comprised in the first pagination workflow.

In some embodiments, a client interface of the user is configured to display N pages simultaneously with N being a positive integer, and the method also includes: in response to that the number of pages comprised in the first pagination workflow is greater than N, presenting, in the client interface, N pages ranked lower in the first pagination workflow, the N pages ranked lower excluding the interaction window; and in response to re-invoking of the digital assistant, adjusting an order of the interaction window in the first pagination workflow so that the interaction window is presented in the client interface.

In this way, if there are too many pages included in the first pagination workflow to be fully displayed, only a portion of the pages are displayed according to certain rule. In some cases, the interaction window may not be displayed. So, if the digital assistant is invoked again, the sorting of the interaction window in the first pagination workflow may be adjusted to present the interaction window in the client interface.

In some embodiments, the interaction window includes a conversational mode window between the user and the digital assistant, and a plurality of interaction messages related to the first page collection between the user and the digital assistant are presented in an aggregated form in the conversational mode window.

In this way, if there are many interaction messages, a plurality of interaction messages may be aggregated and displayed in the conversation mode window. As such, users may expand interaction messages thereof or not expand the interaction messages according to their own needs.

In some embodiments, the form of aggregation includes the form of topic messages.

In some embodiments, the identifier of the at least one page or the identifier of the first page collection is presented in the conversational mode window together with the plurality of interaction messages in the aggregated form.

The target operation may be one or more operations. In some embodiments, the target operation includes a first operation and a second operation. So, performing the target operation comprises: presenting an interaction message from the digital assistant through the interaction window, the interaction message indicating the user to confirm a result of the first operation; and in response to receiving confirmation of the user on the result, performing the second operation based on the result. For example, the first instruction is “generate an XX file based on the information in the AA page and forward it to the YY group”. So, the digital assistant performs the first operation based on this instruction, that is, generating an XX file based on the information on the AA page. Afterwards, a prompt message is displayed, such as “confirm the XX file and forward to YY group”. After confirmation by the user, the digital assistant performs the second operation, that is, forward the file to YY group.

In some embodiments, the target operation includes updating a target page. So, the method further includes in response to completion of the target operation, providing, in the interaction window, an option regarding whether to display the updated target page. For example, after the digital assistant forwards the XX file to the YY group, it prompts the user in the interaction window whether to present the YY group page, which facilitates the user's subsequent operations.

It should be understood that, without violating the concept of the process 800, one or more steps, features, characteristics, or combinations thereof described in the information processing process referred to in the above examples may also be appropriately integrated into the process. The present disclosure will not elaborate further on this matter.

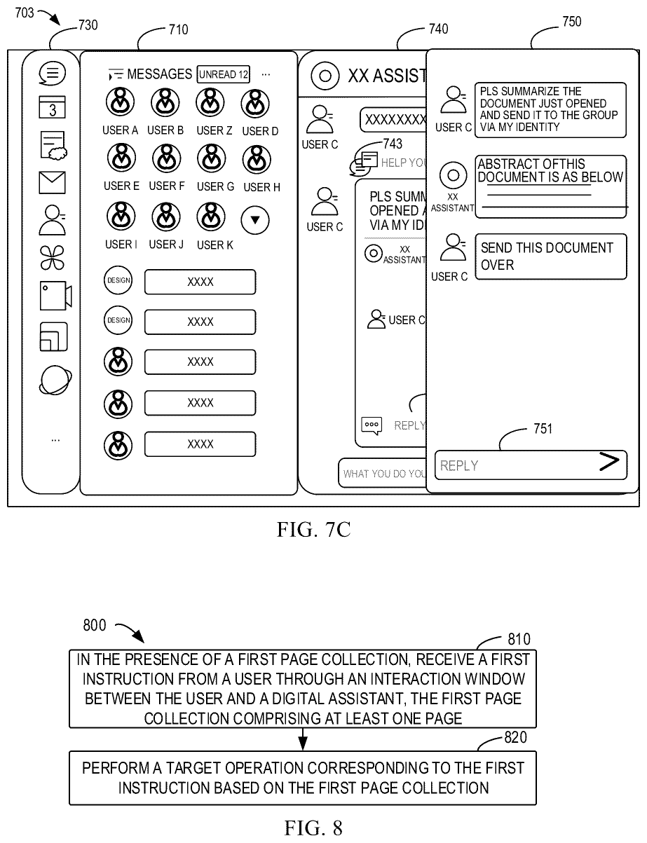

FIG. 9 shows a schematic structural diagram of an apparatus 900 for information processing according to some embodiments of the present disclosure. The apparatus 900 may be implemented or included in the terminal device 110. The various modules/components in the apparatus 900 may be implemented by hardware, software, firmware, or any combination of them.

As shown in FIG. 9, the apparatus 900 includes an instruction receiving module configured to in the presence of a first page collection, receive a first instruction from a user through an interaction window between the user and a digital assistant, the first page collection comprising at least one page. The apparatus 900 also includes an operation execution module configured to perform a target operation corresponding to the first instruction based on the first page collection.

In some embodiments, the first page collection includes one or more of: a collection of pages that have been manipulated during a pre-determined time period; a collection of pages that have been manipulated during a pre-determined time period and are in an open state upon receiving the first instruction; a collection of pages identified as associated with each other based on a user input; a collection of pages that are in an open state and meet a pre-determined association condition; or a collection of pages opened in association.

In some embodiments, the interaction window is presented in response to an invoking operation on the digital assistant in the first page collection.

In some embodiments, the first page collection comprises a first pagination workflow composed of pages opened in association.

In some embodiments, the invoking operation on the digital assistant in the first page collection comprises: triggering an entry control for the digital assistant displayed at a pre-determined position on a first page, or performing a pre-determined operation on the first page to invoke the entry control for the digital assistant and triggering the invoked entry control; wherein the first page is one of pages comprised in the first page collection.

In some embodiments, the apparatus 900 also includes an information obtaining module configured to in response to the invoking operation on the digital assistant in the first page collection, obtain information of the first page collection to enable the target operation corresponding to the first instruction to be perform based on the first page collection upon receiving the first instruction.

In some embodiments, the apparatus 900 also includes a presentation module configured to present prompt information in the interactive window to prompt the user that the digital assistant is currently working based on the first page collection.

In some embodiments, the prompt information includes an identification of the at least one page or an identification of the first page collection.

In some embodiments, the first page collection comprises a first pagination workflow composed of pages opened in association; the interaction window is one of the pages comprised in the first pagination workflow.

In some embodiments, a client interface of the user is configured to display N pages simultaneously with N being a positive integer. The presentation module is further configured to in response to that the number of pages comprised in the first pagination workflow is greater than N, present, in the client interface, N pages ranked lower in the first pagination workflow, the N pages ranked lower excluding the interaction window.

In some embodiments, the apparatus 900 also includes an adjustment module configured to in response to re-invoking of the digital assistant, adjust an order of the interaction window in the first pagination workflow so that the interaction window is presented in the client interface.

In some embodiments, the interaction window comprises a conversational mode window between the user and the digital assistant, and a plurality of interaction messages related to the first page collection between the user and the digital assistant are presented in an aggregated form in the conversational mode window.

In some embodiments, the aggregated form includes a topic message form.

In some embodiments, the identification of the at least one page or the identification of the first page collection is presented in the conversational mode window together with the plurality of interaction messages in the aggregated form.

In some embodiments, the interaction window further comprises a non-conversational mode window between the user and the digital assistant. The apparatus 900 further includes a synchronization module configured to synchronize, to the conversational mode window, interaction information about the first page collection in the non-conversational mode window.

In some embodiments, the presentation module is further configured to in the presence of a plurality of page collections comprising the first page collection, before receiving the first instruction from the user, present a page collection selection control.

In some embodiments, the instruction receiving module is further configured to receive selection of the user on the first page collection through the page collection selection control.

In some embodiments, the target operation includes a first operation and a second operation. The operation execution module is further configured to present an interaction message from the digital assistant through the interaction window, the interaction message indicating the user to confirm a result of the first operation; and in response to receiving confirmation of the user on the result, perform the second operation based on the result.

In some embodiments, the target operation includes updating the target page. The presentation module is further configured to in response to completion of the target operation, providing, in the interaction window, an option regarding whether to display the updated target page.

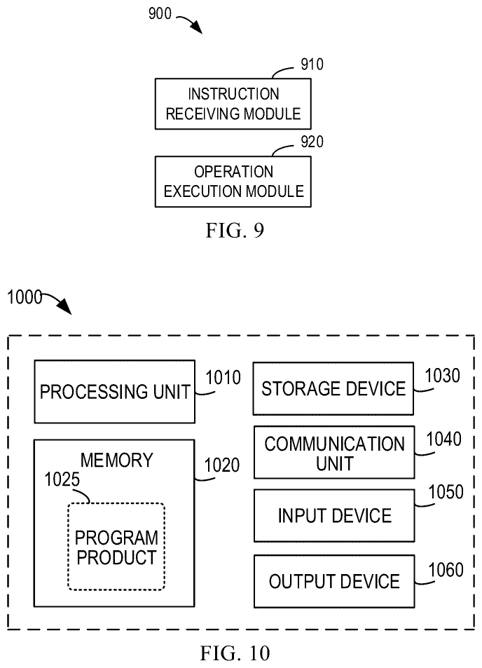

FIG. 10 illustrates a block diagram of an electronic device 1000 in which one or more embodiments of the present disclosure may be implemented. It should be understood that the electronic device 1000 shown in FIG. 10 is merely exemplary and should not constitute any limitation on the functionality and scope of the embodiments described herein. The electronic device 1000 shown in FIG. 10 may be used to implement the terminal device 110 or the server 130 of FIG. 1.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communications units 1040, one or more input devices 1050, and one or more output devices 1060. The processing unit 1010 may be an actual or virtual processor and can perform various processes according to programs stored in the memory 1020. In a multiprocessor system, a plurality of processing units execute computer executable instructions in parallel, so as to improve the parallel processing capability of the electronic device 1000.

The electronic device 1000 typically includes a number of computer storage media. Such media may be any available media that are accessible by electronic device 1000, including, but not limited to, volatile and non-volatile media, removable and non-removable media. The memory 1020 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 1030 may be a removable or non-removable medium and may include a machine-readable medium such as a flash drive, a magnetic disk, or any other medium that can be used to store information and/or data (e.g., training data for training) and that can be accessed within the electronic device 1000.

The electronic device 1000 may further include additional removable/non-removable, volatile/nonvolatile storage media. Although not shown in FIG. 10, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 1020 may include a computer program product 1025 having one or more program modules configured to perform various methods or actions of various embodiments of the present disclosure.

The communication unit 1040 implements communication with other electronic devices through a communication medium. In addition, functions of components of the electronic device 1000 may be implemented by a single computing cluster or a plurality of computing machines, and these computing machines can communicate through a communication connection. Thus, the electronic device 1000 may operate in a networked environment using logical connections to one or more other servers, network personal computers (PCs), or another network node.

The input device 1050 may be one or more input devices such as a mouse, keyboard, trackball, etc. The output device 1060 may be one or more output devices such as a display, speaker, printer, etc. The electronic device 1000 may also communicate with one or more external devices (not shown) such as a storage device, a display device, or the like through the communication unit 1040 as required, and communicate with one or more devices that enable a user to interact with the electronic device 1000, or communicate with any device (e.g., a network card, a modem, or the like) that enables the electronic device 1000 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions. Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method of information processing, comprising:
in the presence of a first page collection, receiving a first instruction from a user through an interaction window between the user and a digital assistant, the first page collection comprising at least one page; and
performing a target operation corresponding to the first instruction based on the first page collection.

2. The method of claim 1, wherein the interaction window is presented in response to an invoking operation on the digital assistant in the first page collection.

3. The method of claim 2, wherein the invoking operation on the digital assistant in the first page collection comprises:
triggering an entry control for the digital assistant displayed at a pre-determined position on a first page, or
performing a pre-determined operation on the first page to invoke the entry control for the digital assistant and triggering the invoked entry control;
wherein the first page is one of pages comprised in the first page collection.

4. The method of claim 2, further comprising:
in response to the invoking operation on the digital assistant in the first page collection, obtaining information of the first page collection to enable the target operation corresponding to the first instruction to be perform based on the first page collection upon receiving the first instruction.

5. The method of claim 1, wherein the first page collection comprises one or more of:
a collection of pages that have been manipulated during a pre-determined time period;
a collection of pages that have been manipulated during a pre-determined time period and are in an open state upon receiving the first instruction;
a collection of pages identified as associated with each other based on a user input;
a collection of pages that are in an open state and meet a pre-determined association condition; or
a collection of pages opened in association.

6. The method of claim 1, further comprising:
presenting prompt information in the interactive window to prompt the user that the digital assistant is currently working based on the first page collection.

7. The method of claim 6, wherein the prompt information comprises an identification of the at least one page or an identification of the first page collection.

8. The method of claim 1, wherein the first page collection comprises a first pagination workflow composed of pages opened in association; and
the interaction window is one of the pages comprised in the first pagination workflow.

9. The method of claim 8, wherein a client interface of the user is configured to display N pages simultaneously with N being a positive integer, and the method further comprises:
in response to that the number of pages comprised in the first pagination workflow is greater than N, presenting, in the client interface, N pages ranked lower in the first pagination workflow, the N pages ranked lower excluding the interaction window; and
in response to re-invoking of the digital assistant, adjusting an order of the interaction window in the first pagination workflow so that the interaction window is presented in the client interface.

10. The method of claim 1, wherein,
the interaction window comprises a conversational mode window between the user and the digital assistant, and a plurality of interaction messages related to the first page collection between the user and the digital assistant are presented in an aggregated form in the conversational mode window.

11. The method of claim 10, wherein the aggregated form comprises a topic message form.

12. The method of claim 10, wherein the identification of the at least one page or the identification of the first page collection is presented in the conversational mode window together with the plurality of interaction messages in the aggregated form.

13. The method of claim 10, wherein the interaction window further comprises a non-conversational mode window between the user and the digital assistant, and the method further comprises:
synchronizing, to the conversational mode window, interaction information about the first page collection in the non-conversational mode window.

14. The method of claim 1, wherein before receiving the first instruction from the user, the method further comprises:
in response to presence of a plurality of page collections comprising the first page collection, presenting a page collection selection control; and
receiving selection of the user on the first page collection through the page collection selection control.

15. The method of claim 1, wherein the target operation comprises a first operation and a second operation, and performing the target operation comprises:
presenting an interaction message from the digital assistant through the interaction window, the interaction message indicating the user to confirm a result of the first operation; and
in response to receiving confirmation of the user on the result, performing the second operation based on the result.

16. The method of claim 1, wherein the target operation comprises updating a target page, and the method further comprises:
in response to completion of the target operation, providing, in the interaction window, an option regarding whether to display the updated target page.

17. An electronic device comprising:
at least one processing unit; and
at least one memory coupled to the at least one processing unit and storing instructions for execution by the at least one processing unit, the instructions, when executed by the at least one processing unit, causing the electronic device to perform acts for information processing, the acts comprising:
in the presence of a first page collection, receiving a first instruction from a user through an interaction window between the user and a digital assistant, the first page collection comprising at least one page; and
performing a target operation corresponding to the first instruction based on the first page collection.

18. The device of claim 17, wherein the first page collection comprises a first pagination workflow composed of pages opened in association; and
the interaction window is one of the pages comprised in the first pagination workflow.

19. The device of claim 18, wherein a client interface of the user is configured to display N pages simultaneously with N being a positive integer, and the acts further comprise:
in response to that the number of pages comprised in the first pagination workflow is greater than N, presenting, in the client interface, N pages ranked lower in the first pagination workflow, the N pages ranked lower excluding the interaction window; and
in response to re-invoking of the digital assistant, adjusting an order of the interaction window in the first pagination workflow so that the interaction window is presented in the client interface.

20. A computer-readable storage medium having a computer program stored thereon, the computer program, when executed by a processing unit, performing acts for information processing, the acts comprising:
in the presence of a first page collection, receiving a first instruction from a user through an interaction window between the user and a digital assistant, the first page collection comprising at least one page; and
performing a target operation corresponding to the first instruction based on the first page collection.
